(19) United States
(12) Patent Application Publication
(10) Pub. No.: US 2014/0060265 A1
(43) Pub. Date: Mar. 6, 2014

(54) SHOCK ABSORBING TOOL BITS

(71) Applicant: COMBINED PRODUCTS CO. #1 INC., CHICAGO, IL (US)

(72) Inventor: Burton Kozak, Chicago, IL (US)

(73) Assignee: COMBINED PRODUCTS CO. #1 INC., CHICAGO, IL (US)

(21) Appl. No.: 14/012,317

(22) Filed: Aug. 28, 2013

Related U.S. Application Data
(60) Provisional application No. 61/693,949, filed on Aug. 28, 2012.

(51) Int. Cl. B25B 23/00; B25B 15/00

(52) U.S. Cl. CPC B25B 23/00; B25B 15/001
USPC 81/436; 81/184

(57) ABSTRACT

A tool bit having a first end, a second end including an engagement portion for engaging a tool, a shank extending longitudinally between the tip and the engagement portion, and a spring, the spring being fixed to the shank in a manner such that the spring remains in a substantially static position while the tool bit is in use.

### RELATED APPLICATIONS

This application claims priority to U.S. Provisional Application Ser. No. 61/693,949 entitled “Shock Absorbing Tool Bits and Tool Bit Holders, Extensions, and Adapters” filed Aug. 28, 2012, the contents of which are fully incorporated herein by reference.

### FIELD OF THE INVENTION

The present invention is directed to tool bits and tool bit holders and extensions having shock and vibration absorption capabilities.

### BACKGROUND OF THE INVENTION

Hand and power tool bits, bit holders, and bit extensions currently used in the art are generally rigid, solid pieces which have very little to no give when in use. Because of the rigid, solid nature, when using known tools bits, bit holders, and bit extensions, any impact, shock, or vibration is transmitted through the bit to the user holding the tool or power tool to which the bit is connected. For example, when using a hammer drill, the impact of the bit typically transmits great amounts of vibration and impact to the user holding the drill. The transmitted vibration and impact may cause inaccurate or inefficient tool use and may lead to discomfort for some users. The impact vibration may likewise cause damage to the device and bit or an associated bit holder as well.

While certain resilient members may be used in the art which allow a tool bit, tool bit holder, or shank to compress or otherwise reduce impact and torque, movement of the bit, bit holder, or shank may likewise cause inaccurate or inefficient tool usage.

Therefore, it would be advantageous to create a tool bit, tool bit holder, tool bit extension, and/or tool bit adapter which has shock and vibration absorption capabilities while the tool bit, tool bit holder, or tool bit extension, remains fixed and rigid to insure maximum accuracy and efficiency while the tool bit, tool bit holder, or tool bit extension are in use.

The present invention is provided to solve these and other issues.

### SUMMARY OF THE INVENTION

Accordingly, the present invention is directed to a tool bit, tool bit holder, and tool bit extension having a statically positioned shock absorber to reduce the effect of any vibrations or impact caused by tool usage.

According to one aspect of the invention, a tool bit having a first end, a second end having an engagement portion, and a shank extending longitudinally between the first end and the second end is provided. The tool bit includes a spring fixed to the shank in a manner such that the spring remains in a substantially static position while the tool bit is in use.

According to another aspect of the invention, the spring may be substantially statically fixed to the exterior of the shank. The tool bit may include a sheath substantially surrounding the shank and spring, which may be made of a rigid or resilient material.

In order to hold the spring in place, rather than affix it directly to the exterior of the shank, at least one anchor may be provided. The spring may be fixedly attached to a portion of the at least one anchor while at least a portion of the at least one anchor may be fixedly attached to the shank. The anchor acts to fix the spring to the shank in a substantially static position while the tool bit is in use.

According to another aspect of the invention, the shank may include a substantially hollow cavity defined therein. Rather than be fixed to the exterior of the shank the spring may be fixed within the cavity in a manner such that the spring remains in a substantially static position while the tool bit is in use. A rod extending longitudinally in the cavity in the shank may be provided. The rod may extend within the interior of the spring, within the coils from one end of the cavity to the other.

The tool bit may include a shoulder located between the shank and the tip. The shoulder may form the upper bound of the cavity while the second end forms a portion of the lower bound of the cavity with the shank extending between the shoulder and the second end. A first end of the spring may be attached to the portion of the shoulder which defines the upper bound of the cavity and a second end of the spring may be attached to the portion of the engagement portion which defines the lower bound of the cavity.

Alternatively, at least one anchor may be fixed within the cavity, wherein the spring has one end attached to the at least one anchor. The at least one anchor may be formed from a resilient material.

Other aspects and features of the invention will become apparent to those having ordinarily skill in the art upon review of the following Description, Claims, and associated Drawings.

### BRIEF DESCRIPTION OF THE DRAWINGS

FIG. 1 is a side view of a tool bit as contemplated by the invention;

FIG. 2 is a side view of a tool bit as contemplated by the invention;

FIG. 3 is a side view of a tool bit as contemplated by the invention;

FIG. 4 is a close up view of portion A in FIG. 3;

FIG. 5 is a side view of a tool bit as contemplated by the invention;

FIG. 6 is a side view of a tool bit as contemplated by the invention;

FIG. 7 is a side view of a tool bit as contemplated by the invention;

FIG. 8 is a view of FIG. 7 having a portion of an exterior sheath removed;

FIG. 9 is a side view of a tool bit as contemplated by the invention;

FIG. 10 is a cross-section of FIG. 9 having the front portion of FIG. 9 removed;

FIG. 11 is a cross-section of FIG. 9 having the front portion of FIG. 9 removed;

FIG. 12 is a cross-section of FIG. 9 having the front portion of FIG. 9 removed; and

FIG. 13 is a cross-section of FIG. 9 having the front portion of FIG. 9 removed.

### DETAILED DESCRIPTION OF THE PRESENT INVENTION

While the present invention is susceptible of embodiment in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

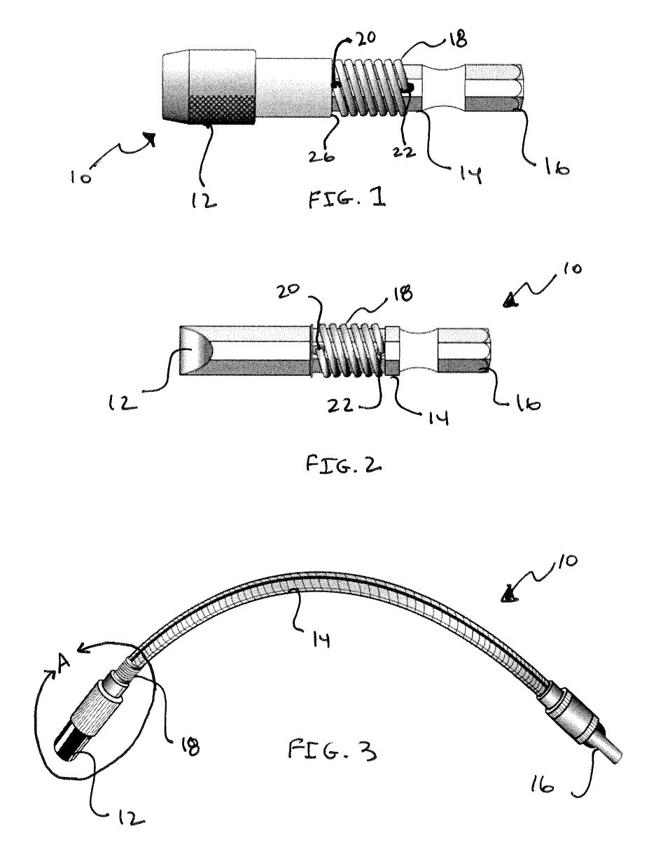

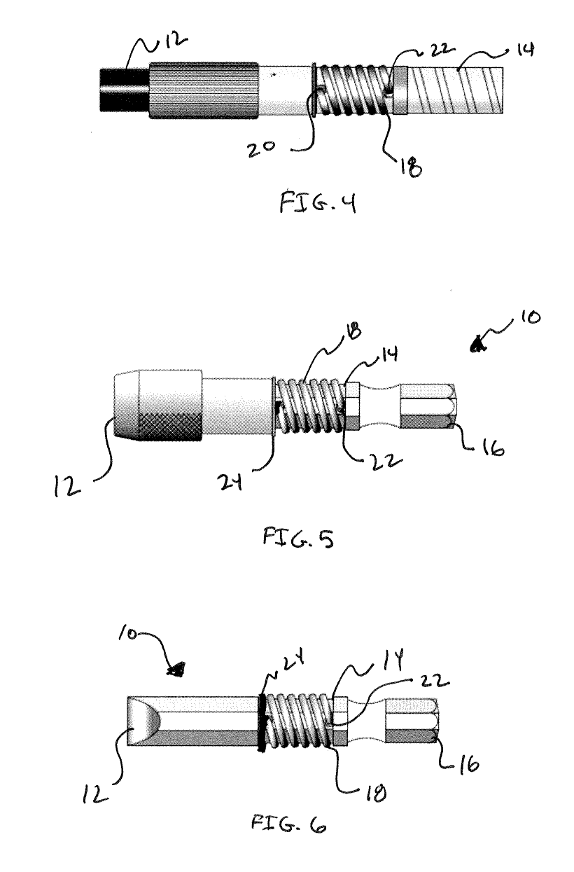

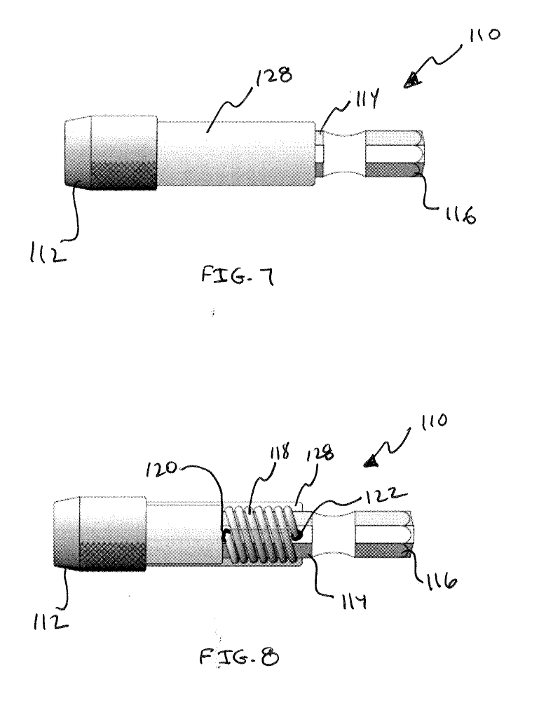

FIGS. 1 and 2 show side views of a tool bit as contemplated by the invention. As seen in FIG. 1, tool bit 10 includes a first end 12, a shank 14, and a second end 16 capable of engaging a tool or chuck for usage. A spring 18 is fixed at both ends to shank 18 so as to remain in a substantially static position relative to first end 12, shank 14, and second end 16 when bit 10 is in use. In addition to the first end, shank, and second end, the bit may include a shoulder, a flute, or any other components known in the art located between the first end and shank.

As used herein, the substantially static position for the spring relative to the elements of the bit means that the first end 20 and second end 22 of the spring are attached to shank 14 and fixed so that first end 20 and second end 22 cannot move during operation. The first and second ends of the spring may be attached to the shank using any means known in the art, including but not limited to welding or through the use of an adhesive. The static fixing of spring 18 substantially prevents either end of the spring from compressing, elongating, twisting, or rotating during operation while the bit is in use. When attached directly to the shank (whether externally as shown in FIGS. 1 and 2, or as explained later internally), the spring likewise provides little, if any force or torque on any part of the bit or any of its components. The fixed spring acts to absorb or reduce vibrations or impacts caused by usage of the bit.

As seen in FIGS. 1 and 2, first end 12 may be a connectable element, like for example a quick connect element, capable of engaging an additional tool bit. When configured to engage an additional tool bit, the first end may be magnetized to facilitate better connection. Alternatively, as seen in FIG. 2, first end 12 may include a tip capable of impacting, manipulating, penetrating, cooperating, or otherwise operating with a surface, fastener, or other device as designed. As used herein, a tool bit may include any insert or body which may be inserted into a hand or power tool for use by an operator. For example, first end 12 may include a drill tip, a Phillips or flathead screw driver tip, or a socket. Though some embodiments may be shown only with a connectable element for further engaging a tool bit, or a tip capable of being used directly, it is contemplated by the invention that first end 12 is substantially interchangeable and that the second end, shank, and spring combination may be utilized with bit ends known in the art.

Second end 16 or the engagement portion of the tool bit may likewise be configured in any manner known in the art so that it may be engaged and held by a hand tool or a power tool. For example, the engagement portion may be hexagonal or round, may be grooved or lipped, may include a quick connect or similar connection—any configuration which allows the bit to engage with a hand tool or chuck on a power tool may be utilized as the second end. The engagement portion may also be a separate and distinct portion formed at the opposite end of the bit as the first end, or may alternatively be formed as an extension or far end of the shank.

Shank 14 may be completely rigid or partially or fully flexible, or have a portion which may be rotated or swiveled as needed. For example, as seen in FIG. 3, shaft 14 may be at least partially flexible to allow for use of the first end of the bit at an angle or location not directly in front of the tool to which the bit is connected. When shank 14 is flexed, bent, rotated or otherwise positioned, any portion of spring 18 connected thereto will likewise be deformed with the shank as both ends are fixed in position. A close up view of the connection between spring 18 and shank 14 can be more easily seen in FIG. 4 which is a close up view of portion A of FIG. 3. When a flexed bit is in use, the spring will remain in a substantially static position relative to the shank while the bit is in use. If the shank is further flexed, bent, rotated, or otherwise positioned during use, the spring will follow the shank and reposition itself relative to the shank, and remain in a substantially static, non-compressed, non-elongated, non-twisted, or non-rotated position relative to the shank, first end 12 and second end 16 until the shank is again flexed, bent, rotated, or otherwise positioned.

Rather than be attached directly to the shank, as seen in FIGS. 5 and 6, spring 18 may be connected to at least one anchor 24, fixed at the end of the spring closest to first end 12. In this configuration, in order to keep spring 18 substantially statically positioned relative to first end 12, shank 14, and second end 18, anchor 24 should be fixed to shank 14. As with spring 18, anchor 24 may be welded, adhered, or attached to shank 14 in any manner known in the art. Anchor 24 may be a standard steel washer, or may be made of a material having resilient properties to provide further enhance shock absorption for the bit. For example, the anchor may be made of nylon, neoprene, rubber, urethane, or a polymer material that allows first end 20 of the spring to attach to the washer and the washer to attach to the shank. It is contemplated by the invention that second end 22 of the spring, the end closest to second end 16 of the bit, may likewise, or alternatively, be attached to a similar or different anchor that is fixed to shank 14. Anchors may be utilized at one or both of the first or second ends of the spring to hold the spring in place rather than attaching the spring directly to the shank. Anchors may be a washer as shown in FIGS. 5 and 6, or alternatively may be a sleeve, or other hollow body which is capable of surrounding and fixing to at least a portion of the shank.

In some embodiments first end 12 or shank 14 may include a lip or shoulder similar to edge 26 in FIG. 1. Rather than attach to the shank, first end 20 of spring 12 may attach directly to the lip or shoulder or similar edge rather than the shank body. A portion of the edge and accompanying body may be made of a resilient material, like for example those mentioned with respect to washers, in order to further enhance the shock absorption of the bit.

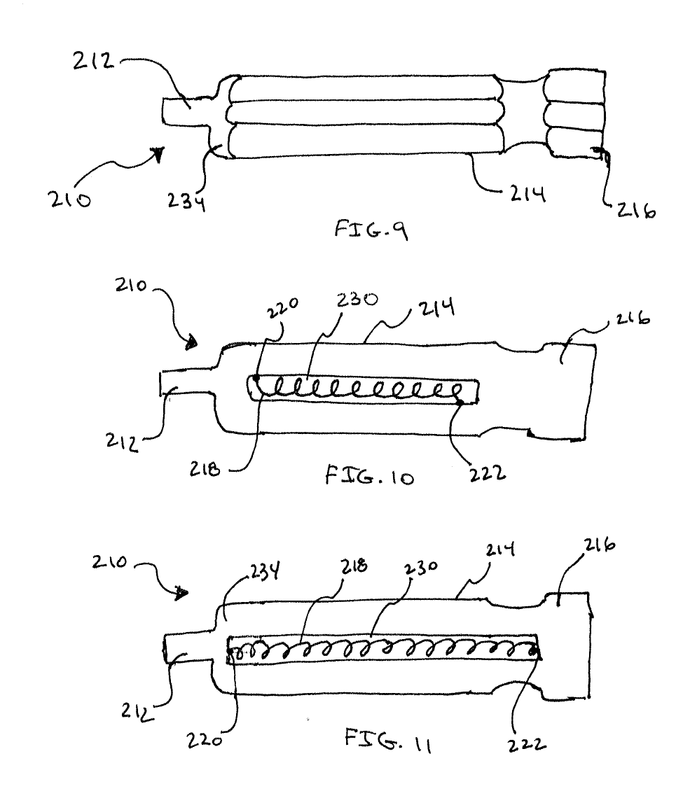

The embodiments shown in FIGS. 1-6 each show spring 18 being exposed, however in order to prevent spring 18 from being snagged, damaged, or engaged during operation, the bit may include a sheath. As seen in FIG. 7, bit 110 may include first end 112, shank 114, and second end 116. A sheath 128 may be included to surround a portion or all of shank 114 and spring 118, which is more clearly seen in FIG. 8 which is shown in FIG. 7 with the front of sheath 128 removed. Like anchor 24 in FIGS. 5 and 6, sheath 128 may be made of a resilient material in order to further enhance the shock absorption of the bit. Sheath 128 may be permanently fixed to shank 114 or bit 110, or alternatively be removably attached to allow for the replacement of spring 118 if it breaks or a spring having different shock absorption qualities is required.

Where a sheath is used, one or more anchors similar to anchor 24 in FIGS. 5 and 6 may be used to anchor one or both ends of spring 118. Where anchors are used, sheath 128 may be configured to surround and cover spring 118, shank 114, and any anchors attached to both the shank and spring. Alternatively, where sheath 128 is permanently fixed to shank 114, first end 120 and/or second end 122 of spring 118 may be fixed to a portion of the sheath. For example, spring 118 may have an end or both ends welded or otherwise attached to a portion of the sheath running parallel to the shank, or to a top or bottom portion of the sheath which partially or fully encloses the interior of the sheath and attaches to shank 114.

Thus far, bit 10 or 110 has been shown with an external spring 18 or 118, and in the case of bit 110 with a sheath 128 surrounding the shank 114 and spring 118 in order to protect it, however it is contemplated that the spring may be located internally, inside the shank.

As seen in FIGS. 9-13 (FIGS. 10-13 being cross-sections of FIG. 9 where the front portion of the bit in FIG. 9 is removed), bit 210 has first end 212, shank 214, and second end 216 which are substantially similar to bits 10 and 110 shown in FIGS. 1-8. Defined within shank 214 is a substantially hollow cavity 230. Spring 218 may be fixed within the cavity in a manner such that the spring remains in a substantially static position while the tool bit is in use like springs 18 and 118 in FIGS. 1-8. In order to anchor the spring within the cavity, first end 220 and second end 222 of the spring may be directly anchored to the shaft within the cavity (FIG. 10), may be anchored to a portion of shoulder 234 or other structure formed as part of the bit (as shown in FIG. 11), may be anchored to a portion of the second end of the tool bit (FIG. 11), or may be anchored to one or more anchors 224 fixed within cavity (as shown in FIG. 12). As with bits 10 and 110, any anchors 224 may be made of resilient material to further enhance the shock absorption properties of the bit. Placing the spring on the inside of shank 214 provides protection and cover for spring 218 without having to add the additional sheath like in FIGS. 7 and 8.

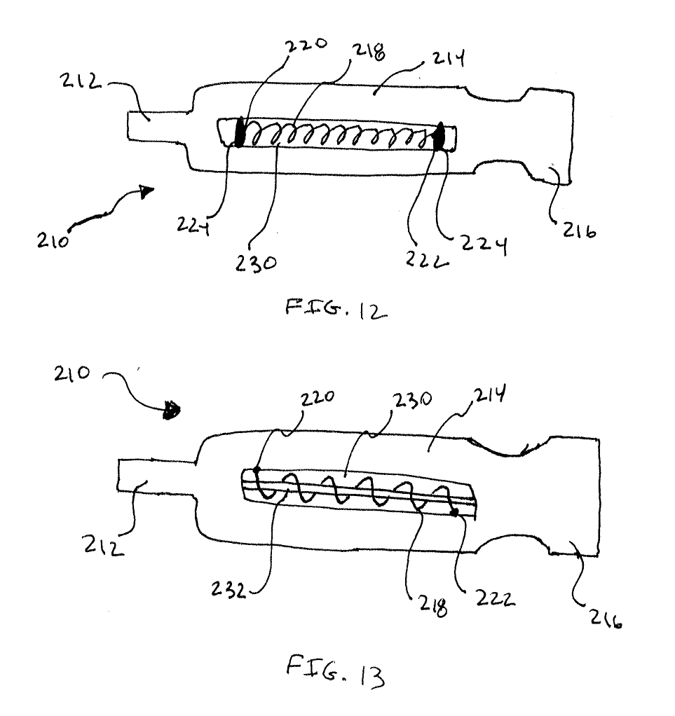

In order to provide additional strength to a bit having an internal cavity 230, as shown in FIG. 13, it is contemplated by the invention that a solid column or rod 232 may be fixed within cavity 230 and extend within the inside of the spring along the entirety of the cavity. In such embodiments, spring 218 may be configured to surround the column or rod, and be substantially statically fixed in the area between the column or rod and interior of the surface forming the shank. Any anchors which are used in conjunction with column or rod 232 may include apertures as needed to allow the column or rod to extend through the entirety of the cavity. It is also contemplated that spring 218 may be fixed at one or both ends directly to the column or rod to maintain its substantially static position.

While in the foregoing there has been set forth as embodiments of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

I claim:

1. A tool bit comprising:
a first end;
a second end having an engagement portion;
a shank extending longitudinally between the first end and the second end; and
a spring, the spring being fixed to the shank in a manner such that the spring remains in a substantially static position while the tool bit is in use.

2. The tool bit of claim 1 wherein the spring is substantially statically fixed to the exterior of the shank.

3. The tool bit of claim 2 further comprising a sheath substantially surrounding the shank and spring.

4. The tool bit of claim 3 wherein the sheath is made of a resilient material.

5. The tool bit of claim 2 further comprising at least one anchor, the spring being fixedly attached to a portion of the one anchor, wherein the at least one anchor having a portion fixedly attached to the shank to fix the spring to the shank in a substantially static position while the tool bit is in use.

6. The tool bit of claim 1 wherein at least a portion of the shank includes a substantially hollow cavity defined therein, wherein the spring is fixed within the cavity in the shank in a manner such that the spring remains in a substantially static position while the tool bit is in use.

7. The tool bit of claim 6 further comprising a rod, the rod extending longitudinally in the cavity in the shank, the rod substantially extending within an interior portion of the spring, the rod extending longitudinally along the entirety of the cavity.

8. The tool bit of claim 2 further comprising a shoulder, the shoulder being located between the shank and the tip.

9. The tool bit of claim 8 wherein the shank extends between the shoulder and the second end.

10. The tool bit of claim 9 wherein
a portion of the shoulder defines an upper bound of the cavity;
a portion of the second end defines a lower bound of the cavity; and
a first end of the spring is attached to the portion of the shoulder which defines the upper bound of the cavity and a second end of the spring is attached to the portion of the second which defines the lower bound of the cavity.

11. The tool bit of claim 6 further comprising at least one anchor fixed within the cavity, wherein the spring has one end attached to the at least one anchor.

12. The tool bit of claim 11 wherein the at least one anchor is formed from a resilient material.

13. The tool bit of claim 1 wherein the first end is capable of engaging a tool bit.

14. The tool bit of claim 13 wherein the first end is a quick connect assembly.

15. The tool bit of claim 13 wherein the first end is magnetic.

16. The tool bit of claim 1 wherein the shank is flexible.

17. The tool bit of claim 1 wherein the first end is a tip.

18. The tool bit of claim 1 wherein the first end is a screw driver head.
